(19) United States
(12) Patent Application Publication
(10) Pub. No.: US 2004/0241595 A1
(43) Pub. Date: Dec. 2, 2004

(54) Method and device for correcting imaging errors of an optical system, and a use of the device

(75) Inventors: Thomas Schatz, Buchbach (DE); Tanja Hagner, Bad Tolz (DE)

Correspondence Address: BEVER HOFFMAN & HARMS, LLP, TRI-VALLEY OFFICE, 1432 CONCANNON BLVD., BLDG. G, LIVERMORE, CA, 94550, US

(73) Assignee: Infineon Technologies AG, Munchen (DE)

(21) Appl. No.: 10/817,145

(22) Filed: Apr. 2, 2004

(30) Foreign Application Priority Data
Apr. 3, 2003 (DE) 10316821.4

(51) Int. Cl. G03C 5/00

(52) U.S. Cl. 430/378

(57) ABSTRACT

A method and a device for determining imaging errors of an optical system in the production of a mask for semiconductor component fabrication, including detecting at least one parameter for the characterization of the mask selecting a stored correction data record from a correction database in a manner dependent on at least one parameter for the characterization of the mask, then determining optical measurable properties of the mask using a measuring system, combining the measurement results of the optical properties with the correction data record associated with the mask in a data processing device, and subsequently storing a measurement data record with the corrected measurement result in a database system. The measurement data record is then used for the correction of imaging errors.

### FIELD ON THE INVENTION

The invention relates to a method for correcting imaging errors, a device for carrying out the method, and a use of this device.

### SUMMARY OF THE INVENTION

In the production of masks for the production of semiconductor components stored design data are converted e.g. by means of an electron beam method into a structure on a substrate (e.g. chrome-on-glass). The patterning is followed by a measurement of the patterned mask, during which the patterning errors, in particular, are determined. Errors may occur in this case in particular in the case of the CD dimension of the mask (CD=critical dimension). The CD dimension specifies the feature size that can be produced during chipmaking. The mask may also have solely or else additionally a positional error of the structure, which is likewise measured.

Fluctuations in the feature sizes produced are a known problem in the production of masks by lithography. Feature size fluctuations are caused in individual steps of the production process, e.g. lens aberrations of the pattern generators.

If the errors of a patterned mask are to be measured, then it is important for the errors, in particular of the CD dimension, to be determined independently of the positioning in the image field of the measuring unit.

The ever shrinking structures on the cellular components make it necessary for the structures on the masks also to become smaller and smaller. By way of example, halftone phase shift masks or alternating phase shift masks are used for this purpose. The wavelengths used also become shorter and shorter and so the development tends towards wavelengths of 248 nm through 193 nm in the direction of 157 nm.

Correction data determined on chrome-on-glass are used in the production of the masks for the shorter wavelengths (e.g. 248 nm MoSi or 193 nm MoSi). Adopting these correction data for the phase shift masks is disadvantageous in this case since the physical conditions of the mask structures and of the mask substrates are different.

### OBJECT OF THE INVENTION

The present invention is provides a method for correcting imaging errors by means of which phase shift masks can also be correctly exposed.

In accordance with an embodiment of the present invention, the method proceeds in the following steps:

a) at least one parameter for the characterization of the mask is detected by a means designed for this purpose,

b) a stored correction data record is selected, in particular automatically, from a correction database in a manner dependent on at least one parameter for the characterization of the mask, then

c) optical measurable properties of the mask, in particular of a structure of the mask, being determined by means of a measuring system,

d) the measurement results of the optical properties being combined with the correction data record associated with the mask in a data processing device, and subsequently

e) a measurement data record with the corrected measurement result being stored in a database system.

It is thus possible to employ precisely the correction data record which is specifically matched to the mask material respectively selected. This avoids the situation e.g. in which the correction data record for chrome-on-glass masks is also used for phase shift masks.

In this case, it is advantageous if the wavelength at which the mask is used in a photolithography method is used as the parameter for the characterization of the mask. A substance property of the mask could also advantageously be used as the parameter for the characterization of the mask. Both parameters by themselves or else together are suitable for distinguishing masks.

In this case, it is advantageous if the correction data record has information for the correction of inhomogeneities of a radiation source, errors of the measuring system, in particular of an associated CCD chip and/or of optical elements, in particular lenses. These error sources can be stored e.g. in the form of tables or matched functions.

It is also advantageous if the parameter for the characterization of the mask can be identified by an identification means, in particular a bar code.

In a further advantageous refinement of the method according to the invention, CD values and/or positional errors are determined by means of the measuring system as optically measurable properties of the mask.

According to another embodiment of the present invention, a device is provided for carrying out the method described above.

In this case, a means serves for detecting at least one parameter for the characterization of the mask. A correction database has at least one stored correction data record, a data processing means serving for selecting, in particular automatically selecting, a correction data record from the correction database in a manner dependent on at least one parameter for the characterization of the mask. A measuring system serves for determining optically measurable properties of the mask, and a combination means serves for combining the measurement results of the optical properties of the mask with the correction data record associated with the mask. The device also has a means for generating a measurement data record, so that the corrected measurement result can be stored in a database system.

The device can be used in particular for the measurement of CD dimensions and/or positional errors of a CoG mask or of a phase shift mask. The device can also be used for masks for use at wavelengths of 365 nm, 248 nm, 193 nm or 157 nm.

### BRIEF DESCRIPTION OF THE DRAWINGS

The invention is explained in more detail below using a plurality of exemplary embodiments with reference to the figures of the drawings. In which:

FIG. 1 shows a diagrammatic illustration of the method according to the invention.

FIG. 2 shows grey-scale value curves for three mask types for in each case four different structures.

### DETAILED DESCRIPTION OF THE DRAWINGS

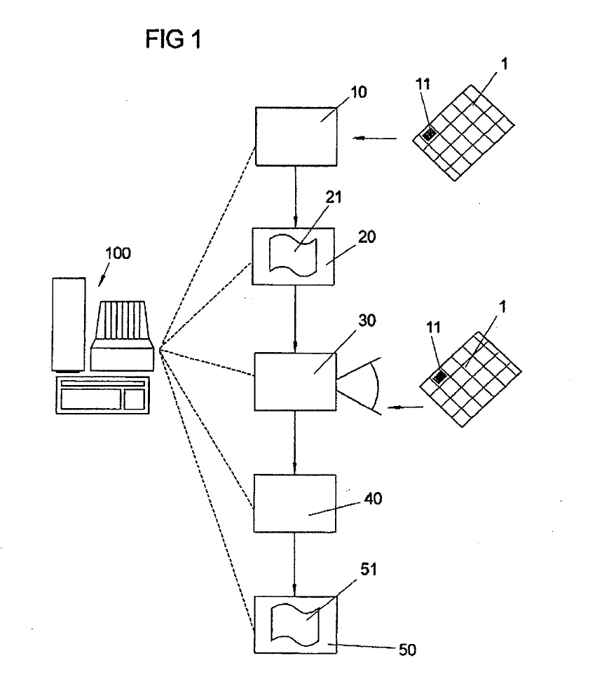

FIG. 1 diagrammatically illustrates the elements which are necessary for carrying out embodiments of the method according to the invention. In this case, a mask 1 to be measured is illustrated diagrammatically on the right, the said mask having been patterned in a manner known per se.

The object is to detect the CD dimensions and/or the positional errors of this patterned mask.

For this purpose, according to the invention, a means 10 for detecting at least one parameter for the characterization of the mask is used to ascertain what type of mask is present. This is necessary since, in contrast to the known method, the intention is not simply to transfer parameters from a chrome-on-glass mask to other mask types.

The characterization may be effected e.g. on the basis of the wavelength at which the mask 1 is used. Moreover, the characterization may be effected by means of a bar code 11 as identification means, the said bar code being arranged on the mask and having the necessary data. Moreover, the characterization may be effected by means of the mask materials used. In this case, the means 10 for detecting at least one characterization parameter may have manual inputs and/or also an automatic detection (e.g. a scanner).

A control system 100 acquires the information about the mask 1. The control system 100 automatically selects a previously stored correction data record 21 from a correction database 20 in a manner dependent on the information about the type of mask 1. This ensures that the correction data record 21 appropriate for the mask 1 is used.

The correction data record 21 contains e.g. a shading correction, which compensates for inhomogeneities of an illumination and CCD camera system. This correction is employed during the processing of intensity profiles for a defined measurement field. The correction data record 21 contains tables in which are stored respectively different correction values for the x and y directions. As an alternative, stored functions matched to inhomogeneities once the latter have been measured are also possible. The correction data record 21 also contains data which can compensate for lens aberrations.

The correction data record is in each case created during the first measurement of the chrome-on-glass or phase mask and used for the subsequent measurements on chrome-on-glass or phase masks until the correction data record is adapted anew.

A measuring system 30 subsequently determines optical properties of the masks 1 by determining CD dimensions and/or positional errors.

In a data processing device 40, the data obtained from the measurement result are combined with the correction data record 21, i.e. the corrections are applied to the measured values determined.

Finally, a measurement data record 51 is stored in a database system.

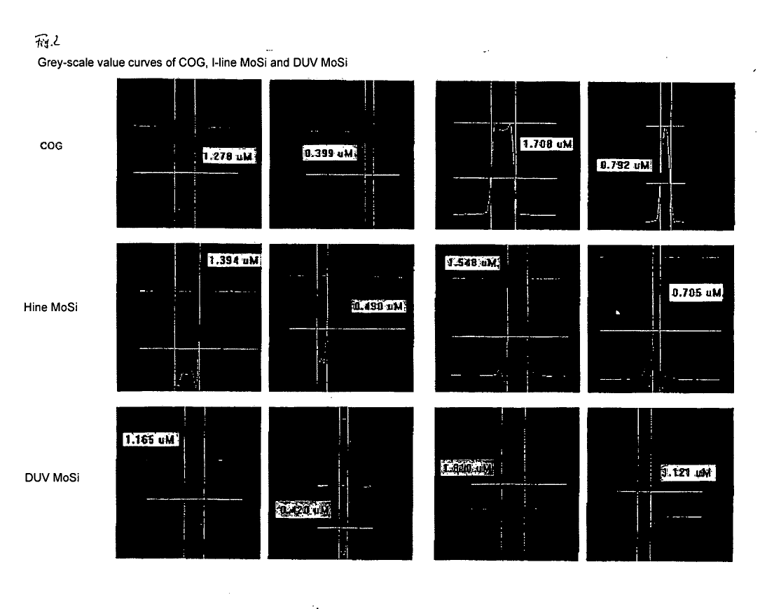

The area of use of the invention can be seen from FIG. 2, which represents grey-scale value curves for three different mask types in the rows, namely CoG, I-line MoSi and DUV MoSi. The columns respectively represent four different structures on a mask which are to be measured. It can clearly be seen that the grey-scale value curves differ greatly between the mask types. In particular, the I-line MoSi and the DUV MoSi mask have grey-scale value curves which have significantly greater overshoots. This shows that the imaging behaviour of the mask types differs, so that it is important to use the respectively appropriate correction data record.

The embodiment of the invention is not restricted to the preferred exemplary embodiments specified above. Rather, a number of variants are conceivable which make use of the method according to the invention also in the case of embodiments of fundamentally different configuration.

List of Reference Symbols

1 Mask

2 Identification means

10 Means for detecting a parameter for the characterization of a mask

20 Correction database

21 Correction data record

30 Measuring system

40 Data processing device

50 Database system

51 Measurement data record

100 Control system

1. A method for determining imaging errors of an optical system in the production of a mask for semiconductor component fabrication, the method comprising:
a) detecting at least one parameter for the characterization of the mask,
b) automatically selecting a stored correction data record from a correction database in a manner dependent on said at least one parameter for the characterization of the mask,
c) measuring optical properties of a structure of the maskusing a measuring system,
d) combining measurement results associated with the measured optical properties with the correction data record associated with the mask in a data processing device to produce a corrected measurement result, and
e) storing a measurement data record with the corrected measurement result in a database system.

2. The method according to claim 1, wherein the parameter for the characterization of the mask is the wavelength at which the mask is used in a photolithography method.

3. The method according to claim 1, wherein the parameter for the characterization of the mask is a substance property of the mask.

4. The method according to claim 1, wherein the correction data record includes information for the correction of inhomogeneities of a radiation source, of the measuring system, in particular of at least one of an associated CCD chip and an optical element.

5. The method according to claim 4, wherein the optical element comprises a lens.

6. The method according to claim 1, wherein the parameter for the characterization of the mask is identified by an identification means.

7. The method according to claim 6, wherein the identification means comprises a bar code.

8. The method according to claim 1, wherein at least one of CD values and positional errors are determined by the measuring system as said measured optical properties of the mask.

9. A device for determining imaging errors of an optical system in the production of a mask for semiconductor component fabrication, the device comprising:
a means for detecting at least one parameter for the characterization of mask,
a correction database with at least one stored correction data record,
a data processing means for automatically selecting a correction data record from the correction database in a manner dependent on said at least one parameter for the characterization of the mask,
a measuring system for determining optically measurable properties of the mask,
means for combining measurement results of the optically measurable properties of the mask with the correction data record associated with the mask to produce a corrected measurement result, and means for generating a measurement data record with the corrected measurement result in a database system.

10. The device according to claim 9, wherein said measuring system includes means for measuring at least one of CD dimensions, and positional errors of one of a CoG mask and a phase shift mask.

11. The device according to claim 9, wherein the mask is designed for wavelengths of 365 nm, 248 nm, 193 nm or 157 nm.
